(19) United States
(12) Patent Application Publication
(10) Pub. No.: US 2026/0160601 A1
(43) Pub. Date: Jun. 11, 2026

(54) SMART TEMPERATURE LOGGER AND CLOUD PLATFORM FOR AUTOMATING TEMPERATURE LOGGING

(71) Applicants: Rakesh Reddy, Boca Raton, FL (US); Kevin Doyle, Pompano Beach, FL (US)

(72) Inventors: Rakesh Reddy, Boca Raton, FL (US); Kevin Doyle, Pompano Beach, FL (US)

(21) Appl. No.: 18/975,669

(22) Filed: Dec. 10, 2024

(51) Int. Cl. G01K 1/022; G01K 1/024

(52) U.S. Cl. CPC G01K 1/022; G01K 1/024; G01K 2207/04

(57) ABSTRACT

Examples herein include systems and methods for temperature logging of food in restaurants, a cloud platform for guiding and analyzing the temperature logging process, and an improved temperature logger for use in the temperature logging process. The temperature logger can include a temperature probe, a user interface, a memory storage, and a hardware-based processor. It can confirm that the temperature of a food item meets applicable requirements, such as requirements provided by the cloud platform. The temperature logger can automatically indicate when a food item is confirmed to be within an acceptable temperature range, prompt the user to check another food item, and report measurement data to the cloud platform. The cloud platform can generate notifications based on the measurement data received from the temperature logger.

### BACKGROUND

In the food industry, maintaining precise temperature control is critical to ensuring food safety and quality. Temperature monitoring of food containers, commonly referred to as “Bains,” is essential to prevent the growth of harmful bacteria and to comply with stringent health regulations. Inadequate temperature management can lead to foodborne illnesses, spoilage, and significant financial losses. Therefore, a reliable and accurate temperature monitoring device is indispensable for businesses such as food-service establishments, catering businesses, and food-processing plants.

In a typical business setting such as a fast-food restaurant, employees may be tasked with measuring many food containers multiple times throughout the day to ensure safety and quality. For example, a fast-food sandwich restaurant may use over 50 food containers concurrently. Different types of food can have different acceptable temperature ranges. In order to test the various food types, an employee must manually measure the temperature of the food in one container and then physically write down the result. The employee is also responsible for ensuring that the measured temperature is within an acceptable range, which in turn requires more work for the employee. These steps present a slow, cumbersome process that is prone to user error or shortcuts. For example, an uninspired employee could easily forge results of temperature testing, subjecting the restaurant's customers to potential danger.

When entities run multiple restaurant locations, it can be difficult to communicate standards for food measurement and monitor compliance with those standards. For example, a sandwich restaurant chain may introduce a new type of meat to replace another food item, where the new meat requires a higher temperature than the replaced food item. This information would typically be disseminated to owners or managers of individual restaurant locations, who in turn instruct their employees accordingly. If this type of information is printed out on paper for reference, they will need to be reprinted to replace the old versions. This process adds administrative burden to the owner or manager of each location. Meanwhile, the corporate headquarters cannot discern the level of adoption of these new standards unless they speak with each owner or manager or receive copies of the papers used to record the temperature.

As a result, a need exists for an improved systems and methods for temperature logging of food and improved temperature loggers. In addition, a need exists for a cloud-based platform that allows an entity to implement company-wide changes, disseminate these changes efficiently to the front-line employees, and receive sufficient feedback and quality control.

### SUMMARY

Examples described herein include systems and methods for improved temperature logging of food, an improved temperature logger, and a cloud platform for automating temperature logging of food.

An example method for temperature logging of food in food containers can include providing a temperature logger. The temperature logger can include a temperature probe, a user interface, a memory storage, and a hardware-based processor. The method can include inserting the temperature probe of the temperature logger into a first food item in a first food container to obtain a first temperature measurement. The method can further include confirming that the first temperature measurement meets a first threshold specific to the first food item. For example, the first threshold can be a range that the food must be within. Confirmation can be performed by the temperature logger or by a user observing the temperature.

In an example, confirmation that a temperature measurement meets a threshold further includes providing an indication of confirmation to a user. For example, the temperature logger can provide an audible noise such as a beep, a visual indication such as a light or a display, haptic feedback such as a vibration, or any combination thereof.

The example method can include automatically cycling to a setting for a second food item in a second food container. For example, the temperature logger can automatically prompt the user to measure the second food item or second food container. The temperature logger can show a picture, a description, a container number, a combination thereof, or any other information that allows a user to understand which container to measure next. The temperature logger can also provide an indication that it is ready to measure the next food item, such as by providing an audible noise such as a beep, a visual indication such as a light or a display, haptic feedback such as a vibration, or any combination thereof. The automatic cycling can be performed based on the confirmation of the first temperature measurement meeting the first threshold, in an example.

The method can include measuring a second food item and confirming that it meets a second threshold associated with the second food item, in the same manner as described with respect to the first food item. This process can repeat as needed until all relevant food items have been measured and recorded. The example method can further include generating an electronic file including data associated with the temperature measurements, such as confirmation that the measurements were performed, the day and time of the measurement, and the results thereof. The method can further include uploading the electronic file to a server for further processing.

In some examples, to make the process even faster, the method can include providing a temperature logger with a temperature forecasting model. The model can use, as an input, a rate of change of temperature measurements. Measuring the rate of change can allow the temperature logger to forecast a final temperature before the final temperature is measured. In some examples, the relevant thresholds include rate-of-change values such that a threshold can be met without a final temperature being recorded, increasing the speed of the measurement process overall.

In an example, the temperature logger can also store a mapping that associates the food containers with particular food items. This can allow the logger to prompt the user to measure a particular food container, while the returned measurement is then associated with a particular food type based on the mapping. The mapping can also indicate an order for measuring the various food types in the containers.

In another example, a cloud platform is provided for automating temperature logging of food in food containers. The cloud platform can include a cloud server that performs various stages. For example, the cloud server can receiving logging requirements and a container mapping from a corporate entity. In the context of this application, the term “corporate entity” is not intended to specify a particular legal form of an entity, but is instead intended to generally describe an entity that owns, operates, manages, or otherwise exerts control over a restaurant location or locations. For example, a restaurant brand may own or franchise hundreds of locations. That brand can have a central office with executives that make decisions that are passed down to those locations. In this example, the executives can be considered the “corporate entity” as distinct from the individual restaurant locations.

Continuing the example, the logging requirements and container mapping can be provided by the corporate entity for use in one or more restaurant locations. The logging requirements can include threshold temperatures and/or threshold rate-of-change of temperatures, each associated with a particular food item. The container mapping can be a file, table, or other information that associates particular food containers with particular food items. The logging requirements and container mapping can be received as electronic files at the cloud server.

The cloud server can also generate instructions based on the logging requirements, where the instructions include one or more thresholds based on rates of change of temperature measurements associated with specific food items. The instructions can be configured to be executed by a temperature logger as described herein. The cloud server can transmit the instructions and mapping to the temperature logger, either directly or indirectly. After temperature measurements are taken in a restaurant, the cloud server can receive measurement data from the temperature logger.

Using the received measurement data, the cloud server can compare the received measurement data to the logging requirements and generate a notification to the corporate entity regarding the comparison. For example, the notification can alert the corporate entity of a failure to meet the logging requirements, such as failing to measure food temperatures with sufficient frequency or failure to maintain proper temperatures. The cloud server can also associate temperature data with particular users, such that patterns and trends can be identified specific to individual users. The cloud platform can be configured to score each user based on their accuracy and thoroughness in taking measurements, and this information can be included in a notification as well. Similarly, the cloud platform can score each restaurant or store relative to other restaurants or stores within the company, region, or any other grouping.

Examples herein also include a temperature logger. The temperature logger can include a temperature probe, a display configured to provide a graphical user interface, a hardware-based processor, and a memory storage housing a plurality of thresholds associated with a plurality of food items and a mapping of the plurality of food items. The temperature logger can be configured to confirm on the display that a first temperature measurement meets a first of the plurality of thresholds. It can also automatically prompt a user to obtain a second temperature measurement. And it can transmit an electronic file to a server, where the electronic file includes data associated with the first and second temperature measurements.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for temperature logging of food according to one or more embodiments herein.

FIG. 2 is a flowchart of an example method performed by a cloud platform for automating temperature logging of food, according to one or more embodiments herein.

FIG. 3 is a schematic of a cloud platform and associated temperature logger according to one or more embodiments herein.

FIG. 4 is a perspective view of an example temperature logger according to one or more embodiments herein.

FIG. 5 is a perspective view of an example temperature logger according to one or more embodiments herein.

FIG. 6 is a perspective view of example food containers within a restaurant for use with one or more of the embodiments herein.

### DESCRIPTION OF THE EXAMPLES

Reference will now be made in detail to the present examples, including examples illustrated in the accompanying drawings.

Examples herein include systems and methods for temperature logging of food in restaurants, a cloud platform for guiding and analyzing the temperature logging process, and an improved temperature logger for use in the temperature logging process. The temperature logger can include a temperature probe, a user interface, a memory storage, and a hardware-based processor. It can confirm that the temperature of a food item meets applicable requirements, such as requirements provided by the cloud platform. The temperature logger can automatically indicate when a food item is confirmed to be within an acceptable temperature range, prompt the user to check another food item, and report measurement data to the cloud platform. The cloud platform can generate notifications based on the measurement data received from the temperature logger.

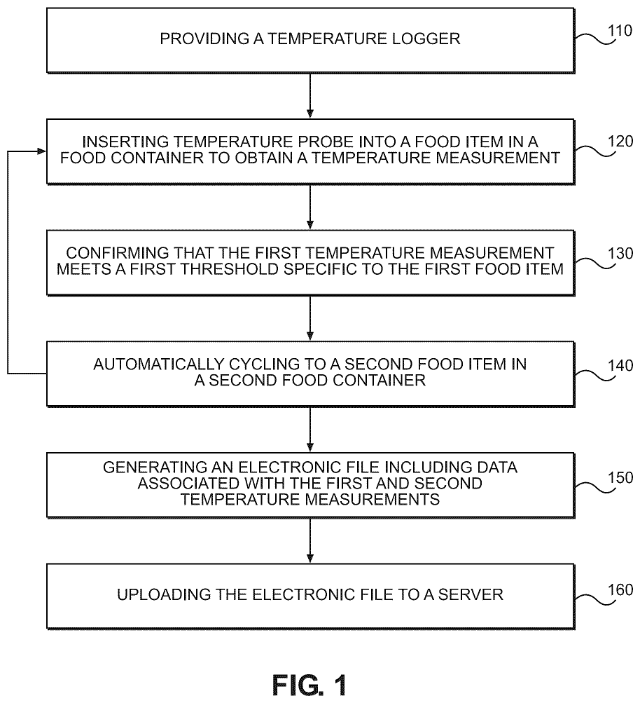

FIG. 1 provides a flowchart of an example method for temperature logging of food. Stage 110 of the example method can include providing a temperature logger. The temperature logger can include at least one temperature probe for inserting into an object or fluid to gather data about the temperature of that object or fluid. In some examples, the temperature logger includes multiple temperature probes for measuring multiple items at the same time, or measuring the same item in multiple locations at the same time. The temperature logger can also include a user interface, which can be one or more physical buttons, one or more displays for displaying a graphical user interface (“GUI”), or a combination thereof. The temperature logger can also include a memory storage configured to store and retrieve electronic files or other electronic instructions. The logger can further include a hardware-based processor that can process and carry out electronic instructions and parse electronic files, as the case may be.

Providing the temperature logger at stage 110 can be performed by the manufacturer of the temperature logger itself, in some examples, such as by making or selling the logger. But it can also be performed by a purchaser of the temperature logger, including a corporate entity that purchases the logger for a particular restaurant location or a restaurant manager that purchases the logger for his or her location. This stage can also be performed by simply making the temperature logger available, such as by a manager providing the logger to an employee or an employee retrieving the temperature logger on their own accord.

Stage 120 can include inserting the temperature probe of the temperature logger into a food item in a food container to obtain a temperature measurement. At this stage, a user (such as an employee at a restaurant) inserts the temperature probe into the food item and holds it there as the temperature of the probe is measured by the temperature logger. The temperature measurement can include an instantaneous measurement in some examples, but it can also include a rate of change of multiple instantaneous measurements of the same food item. As discussed in more detail below, the rate of change can be used to forecast or predict an actual temperature, such that actual temperature can be inferred based on temperature measurements before the temperature measurements indicate the actual temperature.

At stage 130, the temperature logger can confirm that a temperature measurement meets a threshold specific to the food item being measured. In a straightforward example, the threshold can include a temperature value or range of values, such as 40-50 degrees F. If the temperature measurement indicates that the current temperature is within that range, such as 42 degrees F, then the temperature logger can confirm that the threshold is met at this stage.

This stage can also include the application of a temperature forecasting model that allows the temperature logger to confirm that the threshold is met without obtaining a temperature measurement that falls within the threshold range. This can be done by examining the rate of change of the measured temperature and forecasting the actual temperature. If the forecasted actual temperature is within the threshold range within a certain confidence level, the temperature logger can confirm at stage 130.

In more detail, the forecasting model can compare multiple temperature measurements and extrapolate based on a known temperature measurement curve for the temperature logger. As an example, the temperature logger can measure temperatures of 70 degrees F at time T-0, 58 degrees F at time T-1, and 51 degrees F at time T-2. Based on a temperature prediction model, the temperature logger can predict future temperature measurements at future times, such as predicting 47 degrees F at time T-3, 44 degrees F at time T-4, 43 degrees F at time T-5, 42 degrees F at time T-6, and 42 degrees at time T-7. In this example, the predictions level off at 42 degrees F such that the prediction model predicts that the actual temperature (i.e., the temperature that would be determined by leaving the temperature probe in the food item until the temperature stops changing) is 42 degrees F.

The temperature logger can also provide a confidence level of its prediction of the actual temperature, which can rise in confidence as the measured temperature approaches the actual temperature. In this example, the temperature logger can confirm that the temperature of the food item is within an acceptable range, even at time T-2 where the measured temperature is still outside of the range. By confirming the acceptability of the temperature before the actual temperature is confirmed, the method can proceed faster and save time for the user. This same concept can apply where the acceptable temperature range is open ended, such as a threshold that is 50 degrees F or lower.

The confirmation at stage 130 can include an indication to the user of said confirmation. For example, the temperature logger can provide an audible noise such as a beep, chime, or spoken words indicating that the temperature is acceptable. Similarly, the temperature logger can provide a visual indication such as a flashing light, a certain color of light, or a display on the GUI such as a check mark or written words indicating that the temperature is acceptable. Other types of indications can be used, such as haptic feedback from the temperature logger including one or more vibrations or knocks. Of course, any combination of these indications can be provided at this stage.

At stage 140, the temperature logger can automatically cycle to a second food item in a second food container. In this example, cycling to a second food item includes preparing the temperature logger to measure the temperature of the second food item. This can include loading a temperature threshold specific to the second food item. This stage can also include identifying the second food item to the user, such as by identifying the food container in which the second food item resides. As an example, the GUI of the temperature logger can provide a food container number associated with the second food item, a description of the food item, or a combination thereof. For example, the GUI can display the words “Next: tomatoes in container #2.” Any other message can be used based on the use case.

In an example, this stage is automatic from the perspective of the user. For example, the user can receive confirmation at stage 130, and simply remove the temperature probe from the food item. Without any input into the temperature logger from the user, the temperature logger can cycle to settings for a next food item. This process allows a user to move from one food item to the next without needing to press a button or provide input to the GUI.

In an example where the temperature logger determines that no remaining food items remain to be measured at stage 150, then the method can skip stage 140 and proceed to stage 150. Otherwise, if the temperature logger automatically cycles to the next food item at stage 140, then stages 120 and 130 can be repeated for the second food item. That is, the user can insert the temperature probe into the second food item and receive confirmation that the temperature meets a threshold specific to that food item, using the techniques described above in an example.

In some examples, before proceeding to stage 150, the temperature logger determines whether any previous measurements were missed or outside of the relevant threshold, and can automatically prompt the user to measure or remeasure any such food items. This can be useful when a food item is initially outside of the associated threshold but later returns to an acceptable temperature by the time the user has measured the remaining food items.

Stage 150 can include generating an electronic file including data associated with the various temperature measurements taken in the preceding steps of the method. In some examples, the electronic file can include the specific temperature measurements, but in other examples the electronic file can include information summarizing those measurements and/or their results. For example, the file can store a time, location, food item, food container, and measured or predicted actual temperature. In another example, the file can store an indication of whether a particular food item was within an acceptable threshold. The file can also include an indication of a particular user that performed the measurements. Any data generated in stages 110-140 can be included in the file generated at stage 150.

At stage 160, the temperature logger can upload the electronic file to a server, including a group of servers that make up a cloud computing environment. The transfer of the electronic file can be performed wirelessly in some examples, such that the user does not need to plug in a cable to extract the file. In some examples, the transfer of the electronic file is performed automatically upon completion of a temperature measurement process. In other examples, the electronic file can be transmitted at certain times or periodically, which can include the batch transfer of multiple electronic files gathered from multiple measurement processes. For example, the transfer can be performed at the end of each day, which can include measurement data spanning multiple measurement processes that occurred throughout the day. In some examples, the electronic file is simply an indication that all required measurements were performed and found to be acceptable.

By transferring this information to the cloud, a restaurant's owners and managers, such as a corporate entity, can quickly gather information as to the temperature of the food in the restaurant. These and other possibilities enabled by the cloud platform are discussed in more detail below.

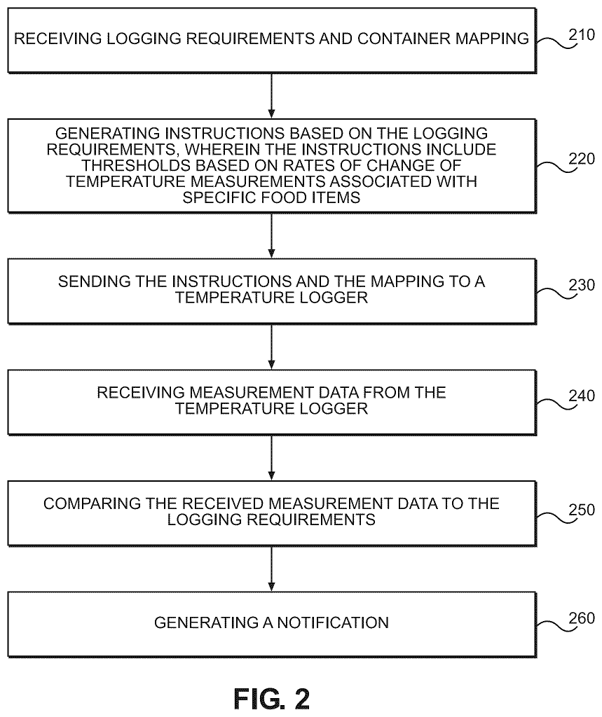

FIG. 2 provides a flowchart of an example method performed by a cloud platform for automating temperature logging of food. At stage 210 of the example method, the cloud platform can receive logging requirements and a container mapping. These items can be received from a corporate entity, such as through an administrative user employed by a corporation that owns multiple restaurants. The term “corporate entity” is used for illustrative purposes only and is not intended to be limiting. The corporate entity could, for example, be an individual user acting in the capacity of a solely owned entity. In the example described with respect to FIG. 2, the corporate entity represents an entity that controls multiple restaurant locations.

The logging information received at stage 210 can include food temperature requirements, in an example. These requirements indicate a temperature or temperature range associated with specific food items. For example, the requirement can be embodied in a table that lists, in one row and column, a type of food such as ground beef. That row of the table can also list, in a second column, a temperature value corresponding to a desired temperature, maximum temperature, or minimum temperature. A subsequent column can include similar information, continuing across multiple columns as needed to include the relevant food temperature requirements.

In some examples, the logging requirements can indicate that the temperature loggers gathering the desired temperature measurements should implement a temperature forecasting model. The logging requirements can specify or provide the model. For example, a forecasting model that utilizes a curve-fitting mechanism can utilize a reference dataset for its comparisons. This reference dataset can be provided in the logging requirements as part of stage 210.

Also as part of stage 210, the cloud platform can receive a container mapping from the corporate entity. The container mapping can associate food containers with food items. For example, a restaurant chain can instruct its restaurants to use food container #1 for chicken, food container #2 for ground beef, and food container #3 for pulled pork. These instructions can be embodied in a table that associates the food containers and food items. In some examples, this table is contained within, and forms a part of, the table described above with respect to the logging requirements. The restaurant mapping can also include a visual indication of the food container layout, such that an employee in the restaurant can ensure that their food layout is in accordance with corporate guidelines.

At stage 220, the cloud platform generates instructions based on at least some of the information received at stage 210. The instructions can be tailored to specific entities, restaurants of an entity, and even to a specific type of temperature logger. For example, some variations of a temperature logger may have different amounts of memory storage or computing power. If a user is likely to use a temperature logger that lacks computing power, for example, the cloud platform can generate instructions that minimize or eliminate the use of temperature forecasting. On the other hand, if a temperature logger has a large memory storage, the cloud platform can generate instructions that require the logger to store additional information in storage, such as high-resolution pictures or videos.

The instructions generated at stage 220 can also include the logging requirements, the container mapping, or both. These items are described with respect to stage 210, but at stage 220 the cloud platform can transform the requirement and mapping into a format usable by the logger. In some examples, the requirements and mapping are received from a corporate entity in a format that cannot be read by the logger, so the cloud platform utilizes its knowledge of the intended logger to format the information in a usable format.

At stage 230, the cloud platform can send the generated instructions to a temperature logger. This can include pushing a notification to the temperature logger indicating that the logger should download the instructions from the cloud platform. The temperature logger can invoke an Application Programming Interface (“API”) to make a call to the cloud platform for the instructions, and accordingly receive one or more electronic files embodying the instructions. The processor of the temperature logger can store any received files in the memory storage of the temperature logger.

Having received the instructions from the cloud platform, the temperature logger can be utilized to take temperature measurements. For example, it can be used to carry out the method described with respect to FIG. 1. The temperature logger can send measurement data to the cloud, and at stage 240 this measurement data is received at the cloud. The cloud can persist this data for use in a variety of way.

One of these ways occurs at stage 250, where the cloud platform compares the received measurement data to the logging requirements. The precise manner of the comparison depends on the form of the measurement data and the logging requirements. For example, the logging requirements may only request an indication that all measurements were performed and met the thresholds during that day. In that case, the comparison may only compare the final results of having met the thresholds during the day with the requirement to perform the same. In other examples, the logging requirements request more granular detail that is included in the measurement data. In order to ensure that the cloud platform receives the correct form of data, the instructions sent at stage 230 can provide instructions regarding selecting, formatting, and sending measurement data back to the cloud.

At stage 260, the cloud platform can generate a notification. The notification can provide any information associated with the measurement data, logging requirements, or comparison thereof. For example, a corporate entity can utilize a mobile app that interfaces with the cloud platform. The mobile app can receive the notification generated at stage 260 and display, on the mobile device, a notification indicating that all temperatures were successfully measured and within thresholds today. This can be provided per store or for multiple stores, such as a region. Although a mobile device and mobile app are described above, the notifications can be provided to any device or application, such as a web browser on a computer or through an API.

The notification can also include an alert. The alert can be generated based on instructions received at stage 210. For example, a corporate entity may decide it wants an alert if the same store fails a temperature check two times within the same week. That requirement can be included in the logging requirements at stage 210, and the cloud platform can use it to generate an alert at stage 260. This can allow the corporate entity to identify and escalate problems much faster than using traditional methods.

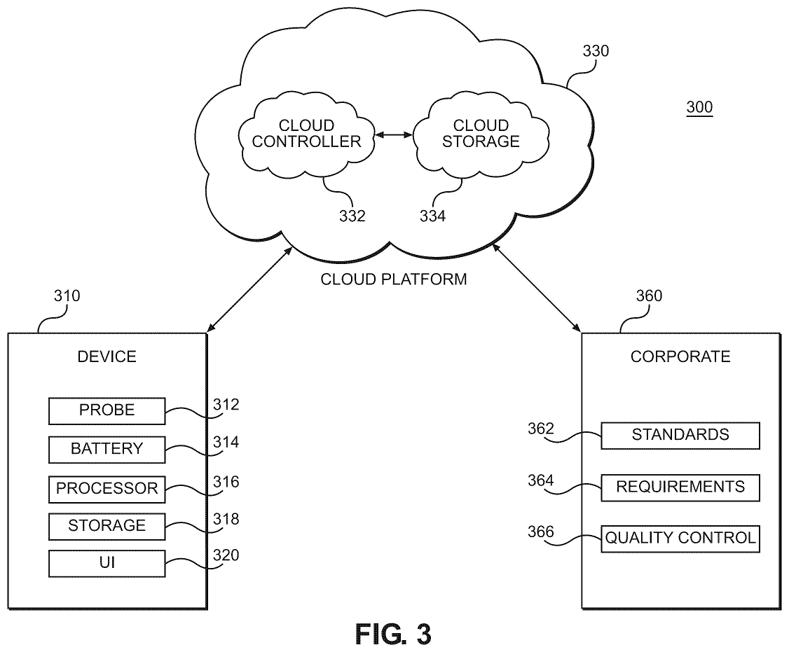

FIG. 3 provides a schematic of a cloud platform 300, such as the cloud platform described above in conjunction with FIG. 2, and associated devices or entities. The cloud platform 300 of FIG. 3 includes a device 310, a cloud server 330, and a corporate device 360. The device 310 can correspond to a temperature logger as described with respect to FIGS. 1 and 2, above. The device 310 can include a temperature probe 312, which can be an elongated member with a sharp tip for puncturing food items. The temperature probe 312 includes a sensor that detects temperature changes and converts them into an electrical signal. The probe 312 can be any type of temperature probe, including a thermocouple, resistance temperature detector, thermistor, or infrared sensor. In an example where an infrared sensor is used, the probe can omit the elongated member which is instead replaced with an infrared sensor housing.

The device 310 can also include a battery 314 for powering the various electrical components of the device 310. The battery 314 can be a traditional alkaline battery, a lithium-ion battery, or any known type of battery. In some examples, the battery 314 is configured to be recharged wirelessly by placing the device 310 on a wireless charging pad. This allows a the device 310 to always be ready for use, provided it is stored in the proper location.

The device 310 can also include a hardware-based processor 316 that can carry out non-transitory, computer-readable instructions stored in the memory storage 318. The memory storage 318 can be a solid state drive that stores electronic files, instructions, and other relevant information.

The device 310 also includes a user interface 320, which can include one or more physical buttons, a digital display, or some combination thereof. The user interface 320 can include a touchscreen display in some examples, where the user is able to interact with the interface 320 by touching the display directly. In examples where the user interface 320 is a digital display, the display can be configured to rotate its orientation based on an orientation of the device 310. For example, based on measurements from an accelerometer and/or gyroscope, the processor 316 of the device 310 can determine an orientation of the device 310 and, based on that determination, instruct the user interface 320 to rotate accordingly. This allows a display of the user interface 320 to be presented in a readable format regardless of the physical orientation of the device 310.

The device 310 can communicate wireless with a cloud server 330, such as by connecting to an API or web socket associated with the cloud server 330. The cloud server 330, though described as a singular server, can be a distributed computing system with numerous computing devices that distribute workloads in an efficient manner. In some examples, the cloud server 330 is a server system provided by a third-party such as GOOGLE or AWS. The cloud server 330 can include a cloud controller 332 and cloud storage 334. The cloud controller 332 can represent one or more processors within the cloud server 330 configured to carry out various operations, such as the relevant stages of FIG. 2 described above. The cloud controller 332 can store information from the device 310 in cloud storage 334, which can be a distributed storage system that persists information across multiple devices in the cloud 330. The cloud storage 334 can also include information received from a corporate device 360.

The corporate device 360 can be any device associated with a corporate entity, such as a mobile phone belonging to an owner, manager, or executive, or a computing device within a corporate office. These examples are not intended to be limiting. The corporate device 360 can include standards 362, such as temperature ranges associated with specific food items or container mappings required to be used in specific restaurants. The corporate device 360 can also include requirements 364, such as a required frequency of temperature testing for specific restaurants. It can also include quality control information 366, which can include instructions for when to notify or alert the corporate entity 360 of certain types of issues. As an example, the quality control information 366 can indicate that if a store fails a temperature measurement check twice within one week, the cloud server 330 should generate an alert and send it to the corporate device 360, as discussed in more detail above with respect to FIG. 2.

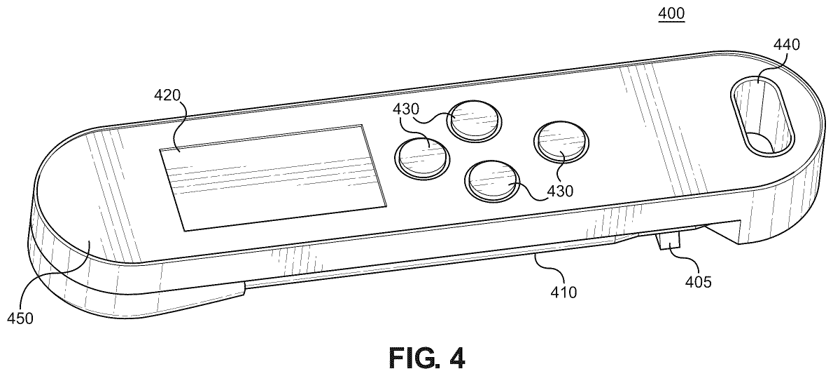

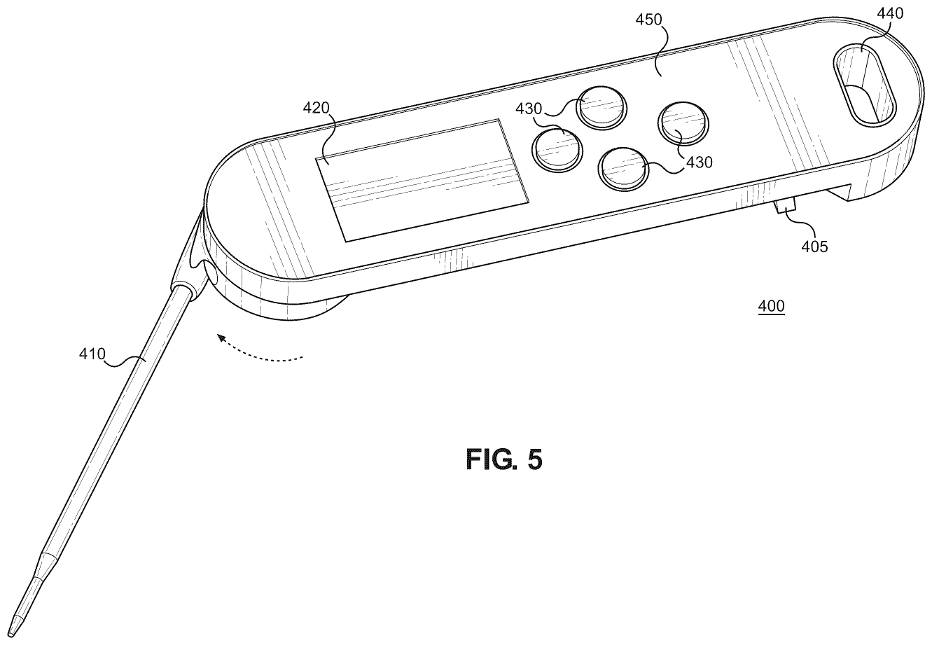

FIGS. 4 and 5 provides perspective views of an example temperature logger 400, which can be used as the temperature logger described with respect to the methods of FIGS. 1 and 2 or as the device 310 of FIG. 3. In this example embodiment, the temperature logger 400 includes a retractable probe 410 that can be used to measure the temperature of an item into which the probe 410 is inserted. The temperature logger 400 can include a switch that turns the temperature logger 400 on when the probe 410 is removed from its storage position (shown in FIG. 4) to a different position (as shown in FIG. 5). This allows a user to skip an additional step of turning the temperature logger 400 on, speeding up the measurement process.

The temperature logger 400 also includes a display 420 that can present a GUI as described previously. The GUI can indicate various types of information to a user. For example, it can indicate the next food item and/or food container that needs to be measured. It can also indicate that the user should maintain the position of the probe 410 until a temperature is measured, such as by informing the user that they should continue waiting or that the temperature is in process of being measured. It can further indicate to the user that the temperature of the measured food item is acceptable, such as by displaying a check mark, a color, or a message indicating success. The GUI can also instruct the user that it is ready to move to the next food item. It can identify the next food item to be measured, such as by identifying the food item itself, the food container that holds the next food item, or a combination thereof.

The temperature logger 400 also includes physical buttons 430 that can be used to interact with the temperature logger 400. These buttons 430 can be used to perform any input functionality required of the temperature logger 400, such as allowing a user to manually select the foot container they want to measure next, indicate that the user is retesting the same food item again, indicate that a food container is empty, indicate that the user has completed all food items, or any other relevant information.

The temperature logger 400 further includes a housing 450 that stores the various components of the temperature logger 400, including the battery, processor, memory storage, and electronics for supporting the display 420 and buttons 430. The housing 450 can include a cutout 440 for conveniently storing the temperature logger 400, such as by hanging it on a hook that places the temperature logger 400 in a position for wireless charging.

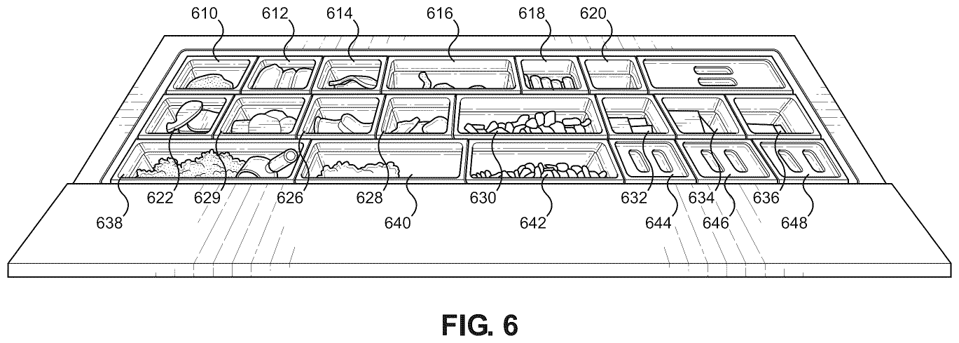

FIG. 6 shows an example food container layout in an example restaurant. Each of the food containers 610-648 include a different food item. In some examples, logging requirements and/or container mappings can dictate the specific food container layout, such as by indicating the position of each size food container and correlating each food container to an intended food type. For example, a container mapping can indicate that container 610 is intended for turkey, container 612 is intended for cheddar cheese, container 614 is intended for American cheese, and so on. The logging requirements can map the particular food items to acceptable temperature ranges for use in the various methods and systems described herein.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for temperature logging of food in food containers, comprising:
providing a temperature logger comprising:
a temperature probe;
a user interface;
a memory storage; and
a hardware-based processor,
inserting the temperature probe into a first food item in a first food container to obtain a first temperature measurement;
confirming that the first temperature measurement meets a first threshold specific to the first food item;
automatically cycling to a setting for a second food item in a second food container;
inserting the temperature probe into the second food item to obtain a second temperature measurement;
confirming that the second temperature measurement meets a second threshold specific to the second food item;
generating an electronic file including data associated with the first and second temperature measurements; and
uploading the electronic file to a server.

2. The method of claim 1, wherein the temperature logger further comprises a temperature forecasting model configured to predict a final temperature before the final temperature is measured.

3. The method of claim 2, wherein the temperature forecasting model uses, as an input, a rate of change of the first temperature measurements.

4. The method of claim 2, wherein the first and second thresholds include rate-of-change values.

5. The method of claim 1, wherein the temperature logger further comprises a mapping that associates the first and second food containers to the first and second food items.

6. The method of claim 5, wherein the mapping further associates the first and second thresholds to the first and second food items.

7. The method of claim 1, wherein confirming first and second thresholds further comprises providing an indication to a user.

8. The method of claim 1, wherein the indication is at least one of an audible noise, a vibration, a light, or a graphical display.

9. The method of claim 1, wherein automatically cycling to the second food item further comprises prompting a user to measure the second food item.

10. The method of claim 9, wherein prompting the user comprises communicating to the user at least one of an identification of the second food item or an identification of the second food container.

11. The method of claim 1, wherein uploading the electronic file to the server is performed in response to a user indicating through the user interface that the user is finished collecting measurements.

12. A cloud platform for automating temperature logging of food in food containers, comprising:
a cloud server that performs a method comprising:
receiving logging requirements and a container mapping from a corporate entity;
generating instructions based on the logging requirements, wherein the instructions include thresholds based on rates of change of temperature measurements associated with specific food items;
sending the instructions and the mapping to a temperature logger;
receiving measurement data from the temperature logger;
comparing the received measurement data to the logging requirements; and
generating a notification to the corporate entity.

13. The cloud platform of claim 12, wherein the logging requirements include a quality control framework.

14. The cloud platform of claim 12, wherein the notification alerts the corporate entity of a failure to meet the logging requirements.

15. The cloud platform of claim 12, wherein the method further comprises receiving at least one of user information and store information associated with the measurement data.

16. The cloud platform of claim 15, wherein the method further comprises using the user information to score a user relative to other users based on the measurement data associated with the user.

17. The cloud platform of claim 15, wherein the method further comprises using the store information to score a store relative to other stores based on the measurement data associated with the store.

18. The cloud platform of claim 12, wherein the notification to the corporate entity indicates whether the received measurement data met the logging requirements.

19. The cloud platform of claim 12, wherein the method further comprises storing measurement data and using stored measurement data to predict failures to meet the logging requirements.

20. A temperature logger comprising:
a temperature probe;
a display configured to provide a graphical user interface;
a memory storage housing a plurality of thresholds associated with a plurality of food items and a mapping of the plurality of food items; and
a hardware-based processor,
wherein the temperature logger is configured to:
confirm on the display that a first temperature measurement meets a first of the plurality of thresholds;
automatically prompt a user to obtain a second temperature measurement; and
transmit an electronic file to a server, the electronic file including data associated with the first and second temperature measurements.
